(19) United States
(12) Patent Application Publication
(10) Pub. No.: US 2022/0365181 A1
(43) Pub. Date: Nov. 17, 2022

(54) A TIME-OF-FLIGHT SENSOR SYSTEM

(71) Applicant: CAMBRIDGE MECHATRONICS LIMITED, Cambridge, Cambridgeshire (GB)

(72) Inventors: Andrew Benjamin Simpson Brown, Cambridge (GB); David Richards, Cambridge (GB)

(21) Appl. No.: 17/770,840

(22) PCT Filed: Oct. 30, 2020
(86) PCT No.: PCT/GB2020/052738

§ 371 Date: Apr. 21, 2022

(30) Foreign Application Priority Data
Nov. 1, 2019 (GB) 1915940.9

(51) Int. Cl. G01S 7/4865; G01S 17/10; G01S 7/481

(52) U.S. Cl. CPC G01S 7/4865; G01S 17/10; G01S 7/4814

(57) ABSTRACT

A time-of-flight sensor system (100) comprising an illumination source (102), an optical system (106) and a sensor (108). The illumination source (102) illuminates a subject (104) to which a time-of-flight is to be measured. The optical system (106) transitions the illumination source (102) between spot illumination and flood illumination. A sensor (108) configured to sense light scattered by the subject (104) from the illumination source (102) and to provide data dependent on sensed light. The time-of-flight sensor system (100) is configured to use the data when the illumination is within a range from spot illumination and/or in a range from flood illumination to provide time-of-flight data.

### FIELD The present invention relates to a time-of-flight sensor system.

### BACKGROUND

A time-of-flight sensor system uses time-of-flight to resolve distance between the sensor and the subject for each point of an image. The time-of-flight is measured, for example, by measuring the round trip time of an artificial light signal or pulse to and then reflected from the subject. Thus, the distance to the subject is half the product of speed of light (3×10⁸ ms⁻¹) and measured time of flight to and from the subject.

A time-of-flight three dimensional (3D) sensor can use light provided by artificial light that is in the form of flood illumination or spot illumination. Flood illumination is where defocused, spatially uniform light is provided over an area of interest. Spot illumination is where light is focused into an array of spots over the area of interest, hence a spatially non-uniform light is provided. Flood illumination gives a high resolution depth map, but with a limited distal range due to the limited intensity of the flood illumination. Spot illumination gives an increased distal range compared to flood illumination, but this reduces the resolution, to the number of pixels illuminated by light scattered from the flood illumination.

It is known to have a time-of-flight 3D sensor that switches between the modes of flood illumination and spot illumination. In the known arrangement, a focusing optical element in the form of a lens is moved by an actuator along an optical axis to defocus the spot illumination to create a flood illumination and then to a focus position to create the spot illumination.

It is also known to have a mode of operation of the time-of-flight 3D sensor where the time-of-flight 3D sensor changes between flood illumination and spot illumination. In this way, high resolution depth information is gathered over short distances by flood illumination and lower resolution depth information is gathered over larger distances by spot illumination. However, with such a known arrangement, data is not gathered as the focussing actuator moves between the flood and focus positions; data is only gathered at the full flood illumination and full spot (focused) illumination positions. As a result, useful time-of-flight data is not collected and lost as the focussing actuator moves between the two positions. FIG. 1 illustrates the loss of measurement time in a known system as the focussing actuator moves between the flood and focus positions. In the graph of FIG. 1, the change in actuator position that moves the lens is shown against time as well as when there is data collection over time (data collection is shown by the shaded area). As illustrated in FIG. 1, data is gathered by a sensor in time periods 12 where the actuator is at the full spot illumination or full flood illumination positions. The sensor does not gather data in between full spot illumination and full flood illumination in time periods 14. This is because the focussing actuator takes a finite time to move between the full flood illumination and full spot illumination positions, in this example, in a period of 33 ms. In some known systems, the focussing actuator may spend less than half the time in the spot illumination and flood illumination positions when data is collected, since considerable time is spent in moving the actuator between these two positions.

### SUMMARY

Contrary to the teaching of the prior art, it has been appreciated that an effective time-of-flight sensor system can be provided which uses data when a sensor senses illumination from an object illuminated with spot illumination, flood illumination as well as illumination that is neither full spot illumination nor full flood illumination. In other words, that an effective time-of-flight sensor system can be provided which uses data when a sensor senses scattered light from an object illuminated within a range from spot illumination and/or in a range from flood illumination to provide time-of-flight data.

It has been appreciated that the effective time for the transition between spot and flood illumination is reduced by making the motion of the focussing actuator asymmetric. This means that the motion and time the focussing actuator spends near the focus or spot illumination position is different from the motion and time the focussing actuator spends near the desired flood illumination position. Thus, the timing of the start of the transition from the flood illumination to the spot illumination position may occur earlier than the timing of the start of the transition from the spot illumination position to the flood illumination position. In some embodiments, the timing of the start of the transition from the flood illumination to the spot illumination position may occur earlier than half way between the times of the start of the transitions from the spot illumination position to the flood illumination position. This allows the duration of the periods when data is gathered to be increased as the required tolerance on the position of the actuator at the flood illumination position is more lax than the required position of the actuator at the spot illumination position. In the example described below, the actuator overshoots the flood illumination position when moving from the spot illumination position to the flood illumination position by a larger amount than the amount that the actuator overshoots the spot illumination position when moving from the flood illumination position to the spot illumination position. The larger overshoot allows the rate of actuator motion to be higher when moving from the spot illumination position to the flood illumination position. This reduces the overall transition time and so allows data to be captured for a larger proportion of the time.

For example, when moving from the spot illumination position to the flood illumination position, the actuator may travel at a higher velocity, and/or at a higher rate of acceleration/deceleration, and/or it may decelerate at a position further along the direction of travel. It has been appreciated that, although such movements may lead to a reduction in actuator precision, this is acceptable because the required tolerance on the position of the actuator at the flood position is more lax than the required position of the actuator at the focus position.

The invention in its various aspects is defined in the independent claims below to which reference should now be made. Optional features are set forth in the dependent claims.

Arrangements are described in more detail below and take the form a time-of-flight sensor system comprising an illumination source, an optical system and a sensor. The illumination source illuminates a subject to which a time-of-flight is to be measured. The optical system transitions the illumination source between spot illumination and flood illumination. A sensor configured to sense light scattered by the subject from the illumination source and to provide data dependent on sensed light. The time-of-flight sensor system is configured to use the data when the illumination is within a range from spot illumination and/or in a range from flood illumination to provide time-of-flight data.

According to a first aspect of the presently-claimed invention, there is provided a time-of-flight sensor system comprising: an illumination source for illuminating a subject to which a time-of-flight is to be measured; an optical system configured to transition the illumination source between spot illumination and flood illumination; and a sensor configured to sense light scattered by the subject from the illumination source and to provide data dependent on sensed light; wherein the time-of-flight sensor system is configured to use the data when the illumination is within a range from spot illumination and/or within a range from flood illumination to provide time-of-flight data.

The time-of-flight sensor system may be configured to use the data within a range from spot illumination and within a range from flood illumination. More specifically, the sensor may provide data during the transition and/or after transition once the illumination source is transited to a position within the range. The range from spot illumination may be smaller than the range from flood illumination. The range from flood illumination may comprise using data from light scattered or reflected when the optical system overshoots the position of flood illumination. The range from flood illumination may comprise using data from light scattered or reflected when the optical system overshoots the position of spot illumination. More specifically, when the transition between spot illumination and flood illumination is respectively effected by focusing and defocussing the illumination source, the range from spot/flood illumination may comprise data from light scattered when illumination source is over-focused or over-defocused beyond their respective predetermined position. The range may refer to a predetermined range of positions that are distal to defined positions of the spot/flood illumination. Spot illumination may comprise a ratio of intensity of illumination at the spots to intensity of illumination between the spots of 20 or greater, such as 30 or greater. In contrast, flood illumination may comprise a ratio of intensity of illumination at spots of the flood illumination to intensity of illumination between the spots of 2 or less, such as 1.5 or less.

The range from spot illumination may comprise a ratio of intensity of illumination at the spots to intensity of illumination between the spots of 15, for spot illumination comprising a ratio of intensity of illumination at the spots to intensity of illumination between the spots of 20 or greater, or 25 for spot illumination comprising a ratio of intensity of illumination at the spots to intensity of illumination between the spots of 30 or greater.

The range from flood illumination may comprise a ratio of intensity of illumination at the spots to intensity of illumination between the spots of 2 to 4.

The optical system may comprise an optical assembly configured to focus and defocus the illumination source. The optical assembly may be configured to focus and defocus using an actuator. The actuator may comprise a shape-memory alloy actuator, a voice coil motor, a microelectromechanical systems magnetic actuator, or any other suitable actuator. The optical assembly may comprise a diffraction grating. The optical assembly may comprise a lens. The optical assembly may comprise a plurality of lenses. The optical assembly may comprise one or more deformable lenses. Spot illumination may be achieved by the optical assembly focussing the illumination source. Flood illumination may be achieved by the optical element defocussing the illumination source. The lens may be movable between a first position to provide spot illumination and a second position spaced from the first position by a distance to provide flood illumination. The first position may be closer to the lens than the second position. This allows for a smaller actuator than the alternative position. In the alternative, the second position may be closer to the lens than the first position. This reduces the stroke required compared to the former configuration. In embodiments with a deformable lens, focussing and defocussing may be achieved by changing the shape of the deformable lens with the actuator. A diffuser may be provided to diffuse the illumination from the illumination source to provide flood illumination. The diffuser may be provided with an actuator to change the light scattered by the diffuser.

The lens may be configured to move within a first distal range from the first position to provide the range from spot illumination, the first distal range being less than ±10% of the distance, less than ±5% of the distance or less than ±2% of the distance. The lens may be configured to move within a second distal range from the second position to provide the range from flood illumination, the second distal range being 1.5 times to 5 times of the first distal range. The illumination source may comprise a dot projector. The dot projector may be any dot projector, for example the dot projector may be formed by a vertical-cavity surface-emitting laser (VCSEL) array.

The sensor may be configured to not provide data when the illumination is not within a range from spot illumination and/or within a range from flood illumination to provide time-of-flight data. The time-of-flight sensor system may comprise a processor. The processor may be configured to only process data when the illumination is within a range from spot illumination and/or within a range from flood illumination to provide time-of-flight data. In the present disclosure, a time-of-flight sensor system is disclosed comprising: a sensor configured to sense light scattered by a subject from an illumination source and to provide data dependent on sensed light; wherein the time-of-flight sensor system is configured to use the data when the sensor senses illumination within a range from spot illumination and/or within a range from flood illumination to provide time-of-flight data.

According to a second aspect of the presently-claimed invention, there is provided a method of sensing light scattered from a subject for a time-of-flight sensor system, the method comprising: illuminating a subject to which a time-of-flight is to be measured with an illumination source; transitioning the illumination source between spot illumination and flood illumination; a sensor sensing light scattered by the subject from the illumination source and providing data dependent on the sensed light; and using the data when the illumination is within a range from spot illumination and/or within a range from flood illumination to provide time-of-flight data.

According to a third aspect of the presently-claimed invention, there is provided a computer program for instructing a computer to perform the method of the second aspect. According to a fourth aspect of the presently-claimed invention, there is provided a non-transitory computer-readable medium comprising instructions for performing the method of the second aspect. The non-transitory computer-readable medium may be, for example, solid state memory.

### BRIEF DESCRIPTION OF THE DRAWINGS

Certain embodiments of the presently-claimed invention will now be described, by way of example only, with reference to the accompanying drawings, in which:

FIG. 1 is a graph illustrating operation of a known time-of-flight sensor system indicating periods where data is gathered against optical element position;

FIG. 2 is a schematic diagram of a time-of-flight sensor system embodying an aspect of the present invention;

FIG. 3 is a graph illustrating movement of a lens of an ideal actuator and a real actuator of a time-of-flight sensor system as they move between flood and spot positions over time;

FIG. 4 is a graph illustrating the ratio of intensity of illumination at the spots to intensity of illumination between the spots at a range of positions of the lens; and

FIG. 5 is a graph illustrating operation of a time-of-flight sensor system embodying an aspect of the present invention indicating periods where data is gathered against optical element position.

### DETAILED DESCRIPTION

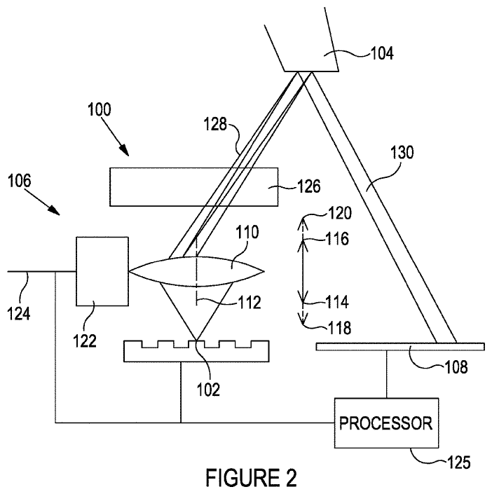

An example time-of-flight sensor system 100 and a method of sensing light scattered from a subject for a time-of-flight sensor system will now be described with reference to FIG. 2. The time-of-flight sensor system is for sensing the time of flight from an illumination source 102 of the system to a subject or three dimensional scene 104.

The time-of-flight sensor system 100 has an illumination source 102; an optical system 106 and a sensor 108. The illumination source 102 is for illuminating the subject 104 to which a time-of-flight is to be measured. In this example, the illumination source is a dot projector formed by a vertical-cavity surface-emitting laser (VCSEL) array. The optical system is located between the illumination source and the subject.

The optical system 106 comprises an optical assembly or element with a lens 110 that focusses and defocuses the illumination source 102. The lens is movable, along an optical axis 112, between a first position 114 to provide spot illumination and a second position 116 spaced from the first position by a distance to provide flood illumination. In spot illumination, in this example, there is a ratio of intensity of illumination at the spots to intensity of illumination between the spots of 30. However, the ratio may be, for example, 20 or greater, or 30 or greater. In flood illumination, in this example, there a ratio of intensity of illumination at spots of the flood illumination to intensity of illumination between the spots of 3. However the ratio may be, for example, 2 or less, such as 1.5 or less. The lens 110 may overshoot the spot illumination position 114 and the flood illumination position 116 (shown schematically in FIG. 2 by spot overshoot position 118 and flood overshoot position 120 respectively).

The optical assembly has an actuator 122, in this example, a shape-memory alloy (SMA) actuator. Another type of actuator may be used, such as voice coil motor (VCM) or voice coil actuator, or a microelectromechanical systems (MEMS) magnetic actuator. The lens 110 is spaced from the illumination source 102. The actuator moves the lens towards and away from the illumination source to focus and defocus illumination, on the subject, from the illumination source, including overshooting the flood and spot illumination positions. The actuator includes an interface 124 to a processor or controller 125, in particular, a computer controller.

In some embodiments (not shown), the lens may be a deformable lens, whereby the actuator is configured to change the shape of the lens to transit between the flood and spot illumination positions, so as to effect focussing and defocussing the illumination.

The optical assembly also includes a diffraction grating 126 located between the lens 110 and the subject 104. The diffraction grating diffracts light from the lens and, in particular, focused light from the lens to provide more spots on the subject. This increases the resolution, which is dependent on the number of spots projected.

Artificial light or illumination 128 from the illumination source 102 forms reflected or scattered light 130 from the subject 104 to the sensor 108 of the time-of-flight sensor system 100. The sensor senses the light scattered by the subject from the illumination source 102.

The processor or controller 125 is in communication connection with the illumination source 102, the actuator 122 and the sensor 108 to control them and receive and process data from them. The controller may be implemented in hardware or in software as a computer program stored in a non-transitory computer-readable medium, which, in this example, is memory of the device on which the time-of-flight sensor system is located, in this example, a smartphone.

Spot illumination is achieved by the controller 125 controlling the actuator 122 to move the lens 110 to focus the illumination source 102 on the subject 104. Flood illumination is achieved by the controller 125 controlling the actuator 122 to move the lens to defocus the illumination source 102 on the subject. However, in practice, actuators do not move between the focus and defocus positions instantaneously. They travel at a finite speed and accelerate and decelerate to a target position. The movement depends on the type of actuator used; they have different characteristics. In the present example, using an SMA actuator, the maximum speed is low. In contrast, VCMs, for example, have a higher maximum speed, but a characteristic ringing of a longer decaying oscillation around the target position to most quickly decelerate to the target position.

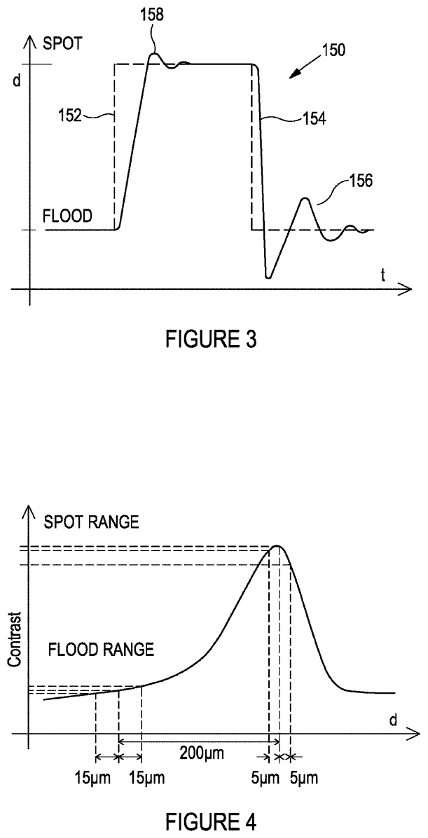

In FIG. 3, the graph 150 illustrates the ideal actuator movement between flood and spot position, d, by a dashed line 152 where the actuator moves instantaneously between flood and spot positions and from spot to flood position. The continuous line 154 of the graph of FIG. 3 illustrates the real actuator movement between target flood and spot positions. It takes a finite time to accelerate and then decelerate and thus to move from flood to spot positions and there are decaying oscillations of the actuator position over time around the target position. Notably, the amplitude and decay time of the decaying oscillations is larger around the flood position (oscillations 156) than at the spot position (oscillations 158).

FIG. 4 illustrates the contrast (ratio of intensity of illumination at the spots to intensity of illumination between the spots) against the position of the lens (distance, d), as the actuator moves the lens away from the illumination source for a typical real SMA actuator. As shown in FIG. 4, the contrast varies with the movement of the lens in a non-linear manner, e.g. the gradient of the curve increases towards the spot position. For an actuator with a lens with a 3 mm focal length, the flood position and the spot position are selected to be 200 μm apart. The range where data is collected is +/−5 μm around the spot position and +/−15 μm around the flood position.

Turning back to the time-of-flight sensor system 100 of FIG. 2, the sensor 108 of the time-of-flight sensor system senses or uses illumination within a range from spot illumination and in a range from flood illumination; not only at full spot and full flood illumination. In this example, the sensor is configured to not provide data when the illumination is not within a range from spot illumination and/or within a range from flood illumination to provide time-of-flight data. Alternatively, the time-of-flight sensor system comprises a processor configured to only process data when the illumination is within a range from spot illumination and/or within a range from flood illumination to provide time-of-flight data. In this example, the range from spot illumination is smaller than the range from flood illumination. This is because it has been appreciated that, as explained above, the actuator 122 overshoots the flood position when moving from the spot position to the flood position by a larger amount than the amount that the actuator overshoots the spot position when moving from the flood position to the spot position. In this example, the range from spot illumination is provided when the lens moves a first distal range from the spot position, the first distal range being within less than ±10% of the distance between the spot position and the flood position. However, in other examples, the first distal range is less than ±5% or less than ±2% from the spot position. The range from flood illumination is provided when the lens moves within a second distal range from the flood position, the second distal range being 1.5 times to 5 times the first distal range. The ranges from spot illumination and flood illumination are intentionally selected ranges. The ranges are predetermined.

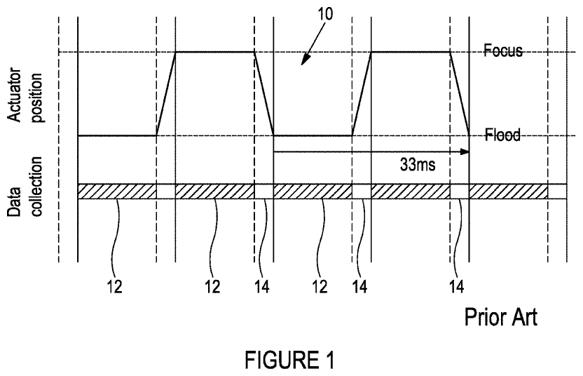

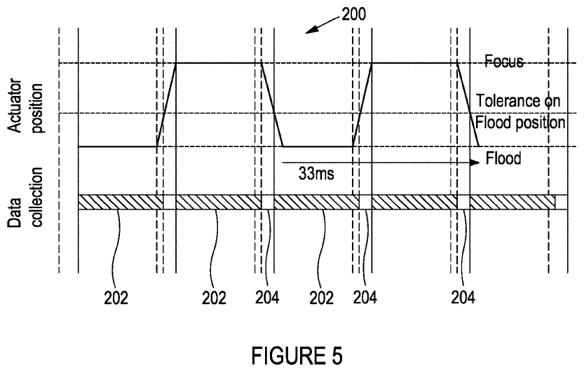

The graph 200 of FIG. 5 illustrates measurement time as the focussing actuator moves between the flood and focus positions. For comparison with the prior art example of FIG. 1, in the example of the graph of FIG. 5, the time to move between the full flood and full focus positions is the same 33 ms. In the example illustrated in the graph of FIG. 5, data is gathered and provided in time periods 202 where the sensor is in full focus and in a range from flood illumination. More specifically, data is gathered and provided during transition and/or after transaction of the illumination when the illumination is in a position within the range. The sensor does not gather or provide data between the focus position and the range from flood illumination as illustrated in FIG. 5 by time periods 204. In the example described, data is gathered and provided for a longer period than in the prior art. Therefore, there is more useful time-of-flight data.

Embodiments of the present invention have been described. It will be appreciated that variations and modifications may be made to the described embodiments within the scope of the present invention. For example, the example time-of-flight sensor system is described as located in a smartphone, however, the time-of-flight sensor system may be located in a computer, such as a laptop computer, tablet computer or desktop computer, in a vehicle, or other consumer device.

1. A time-of-flight sensor system comprising:
an illumination source for illuminating a subject to which a time-of-flight is to be measured;
an optical system configured to transition the illumination source between spot illumination and flood illumination; and
a sensor configured to sense light scattered by the subject from the illumination source and to provide data dependent on the sensed light;
wherein the time-of-flight sensor system is configured to use data provided by the sensor when the illumination is within a range from spot illumination and/or within a range from flood illumination to provide time-of-flight data.

2. A time-of-flight sensor system according to claim 1, wherein the time-of-flight sensor system is configured to use data provided by the sensor when the illumination is within a range from spot illumination and within a range from flood illumination; and the range from spot illumination is smaller than the range from flood illumination.

3. A time-of-flight sensor system according to claim 1, wherein the time-of-flight sensor system is configured to use data provided by the sensor when the illumination is within a range from flood illumination and wherein the data is based on light scattered when the optical system has overshot the point of flood illumination.

4. A time-of-flight sensor system according to claim 1, wherein spot illumination comprises a ratio of intensity of illumination at the spots to intensity of illumination between the spots of 20 or greater, optionally 30 or greater.

5. A time-of-flight sensor system according to claim 1, wherein flood illumination comprises a ratio of intensity of illumination at spots of the flood illumination to intensity of illumination between the spots of 2 or less, optionally 1.5 or less.

6. (canceled).

7. (canceled).

8. A time-of-flight sensor system according to claim 1, wherein the optical system comprises an optical assembly configured to focus and defocus the illumination source.

9. A time-of-flight sensor system according to claim 8, wherein the optical assembly is configured to focus and defocus using an actuator.

10. A time-of-flight sensor system according to claim 9, wherein the actuator comprises a shape-memory alloy actuator, a voice coil motor or a microelectromechanical systems magnetic actuator.

11. A time-of-flight sensor system according to claim 8, wherein the optical assembly comprises a diffraction grating.

12. A time-of-flight sensor system according to claim 8, wherein the optical assembly comprises a lens.

13. A time-of-flight sensor system according to claim 8, wherein spot illumination is achieved by the optical assembly focussing the illumination source.

14. A time-of-flight sensor system according to claim 8, wherein flood illumination is achieved by the optical element defocussing the illumination source.

15. A time-of-flight sensor system according to claim 12, wherein the lens is movable between a first position to provide spot illumination and a second position spaced from the first position by a distance to provide flood illumination.

16. A time-of-flight sensor system according to claim 15, wherein the lens is configured to move within a first distal range from the first position to provide the range from spot illumination, the first distal range being less than ±10% of the distance, less than ±5% of the distance, or less than ±2% of the distance.

17. A time-of-flight sensor system according to claim 16, wherein the lens is configured to move within a second distal range from the second position to provide the range from flood illumination, the second distal range being 1.5 times to 5 times the first distal range.

18. A time-of-flight sensor system according to claim 1, wherein the illumination source comprises a dot projector.

19. A time-of-flight sensor system according to claim 1, wherein the sensor is configured to not provide data when the illumination is not within a range from spot illumination and/or within a range from flood illumination to provide time-of-flight data.

20. A time-of-flight sensor system according to claim 1, wherein the time-of-flight sensor system comprises a processor and the processor is configured to only process data when the illumination is within a range from spot illumination and/or within a range from flood illumination to provide time-of-flight data.

21. A time-of-flight sensor system comprising:
a sensor configured to sense light scattered by a subject from an illumination source and to provide data dependent on the sensed light;
wherein the time-of-flight sensor system is configured to use data provided by the sensor when the illumination is within a range from spot illumination and/or within a range from flood illumination to provide time-of-flight data.

22. A method of determining time-of-flight data, the method comprising:
illuminating a subject to which a time-of-flight is to be measured with an illumination source;
transitioning the illumination source between spot illumination and flood illumination;
using a sensor to sense light scattered by the subject from the illumination source;
providing data dependent on the sensed light; and
using data provided by the sensor when the illumination is within a range from spot illumination and/or within a range from flood illumination to provide time-of-flight data.

23. (canceled).

24. (canceled).
